(19) United States
(12) Patent Application Publication
(10) Pub. No.: US 2003/0200643 A1
(43) Pub. Date: Oct. 30, 2003

(54) Machining center for finishing a patio door sill

(75) Inventors: Todd Frederick, Merrill, WI (US); Dale Len Marquardt, Merrill, WI (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: F-M Enterprises, Inc.

(21) Appl. No.: 10/136,857

(22) Filed: Apr. 30, 2002

(51) Int. Cl. B23Q 41/00

(52) U.S. Cl. 29/564

(57) ABSTRACT

A machining center capable of fabricating and machining both ends of a work piece, such as a patio door sill. The machining center comprises two heads, each of which comprise several machining devices and tools which can perform the necessary machining operations on each end of the sill. Each head is configured to perform a cope, a back weep, a front weep, a screen weep on the sill, and to drill two holes in the sill. The heads are slidably mounted on rails so that the heads are able to travel in the direction of the length of the sill.

### CROSS-REFERENCE TO RELATED APPLICATION(S)

None.

### BACKGROUND OF THE INVENTION

The present invention relates to a machining center capable of machining a variety of products, including specifically a patio door sill. More particularly, the present invention relates to a machining center which is capable of performing multiple machining operations on both ends of a patio door sill.

Patio door sills, which are used in building patio doors, are typically made out of aluminum or fiberglass. Before the sill is incorporated into the patio door frame, a variety of finishing operations must be performed on both ends of the door sill. Included in these finishing operations is a cope, or the removal of a small amount of material from the ends of the bottom sill to allow the vertical portions of the door frame to meet with and be attached to the bottom sill. In addition, a front weep and a back weep are created using a router to allow for water to drain out of the bottom sill. A screen weep must be cut in the bottom sill so that the sill can later accommodate a screen door. Finally, two screw holes are drilled in the bottom of the sill for use later when the vertical portions of the patio door frame are attached to the sill.

In the past, performing these numerous finishing steps on each end of the patio door sill was extremely time-consuming and expensive. Each operation was performed by hand to ensure the high tolerances required could be met. Doing the operations by hand often required inserting the sill into a jig to position and hold the sill during the finishing operation. Then, when the next finishing operation was to be performed, the sill would have to be removed from the jig, repositioned, and inserted into another jig. As a result, several steps were required to perform each operation, which greatly increased the time and cost required to finish the bottom sill.

One possible way to decrease the time and expense of finishing the ends of a patio door sill is to utilize a computer numeric-controlled machine (CNC). A CNC machine can be configured to perform multiple operations on the end of a sill. Though CNC machines may increase the efficiency of performing the finishing operations, such machines are highly expensive. In addition, a CNC machine is typically configured to perform finishing operations on only one end of the door sill at a time. Because the door sill must be finished on the front side of each end, it is not possible to simply machine the left side of the door sill, turn the door sill around, and machine the right side. As a result, a CNC machine which machines one end at of a sill cannot be easily modified to also machine the other end of the sill without changing the orientation of all of the machining devices and tool heads.

Another problem encountered when finishing the ends of a patio door sill is the amount of dust created when performing the finishing operations. In particular, when performing the cope operation, it may be necessary to use a stack of dado blades. Performing a cope cut with a dado blade stack creates a tremendous amount of dust.

Thus, there is a need in the art for a fabricating machine capable of machining both ends of a door sill. The fabricating machine must be inexpensive, perform the operations in a short amount of time, and minimize dust.

### BRIEF SUMMARY OF THE INVENTION

The present invention is a machining center capable of fabricating and machining both ends of an item, such as a door sill for use in a patio door. The machining center comprises two heads, each of which comprise several machining devices and tools which can perform the necessary machining operations on each end of the sill in the proper orientation. The heads are slidably mounted on rails so that the heads are able to travel in the direction of the length of the sill. As a result, the machining center can machine a variety of products and several different lengths of door sills.

The heads are further configured to be movable in the direction of the width of the sill. As a result, a variety of tools used to perform the required finishing operations can be positioned on the head to allow for several machining operations to be performed very quickly. Specifically, the machining operations performed by the machining center include a cope performed by a combination of a horizontal and vertical blade; a back weep performed by a back router; a front weep performed by a front router; a screen weep performed by a vertical router; and two screen holes drilled by two vertical drill heads.

### BRIEF DESCRIPTION OF THE DRAWINGS

FIG. 1 is a perspective view of a portion of a patio door sill.

FIG. 2 is a front perspective view of the portion of the patio door sill showing the cope, drill holes, and screen weep operations.

FIG. 3 is a back perspective view of the portion of the patio door sill showing the back and front weeps.

FIG. 4 is a perspective view a machining center capable of performing multiple machining operations on both ends of a patio door sill.

FIG. 5 is a front view of a portion of the machining center with the hood raised to show a head of the machining center.

FIG. 6A is an end view of the machining center shown in the forward position.

FIG. 6B is an end view of the machining center shown in the start position.

FIG. 7 is an end view of a portion of the machining center illustrating the back router.

FIGS. 8A and 8B are end views of a portion of the machining center illustrating the blades and the operation of the drill heads.

FIG. 9 is an end view of a portion of the machining center illustrating the vertical router and the front router.

FIG. 10 is an end view of a portion of the machining center illustrating a method of holding the sill in place during the finishing operations.

### DETAILED DESCRIPTION

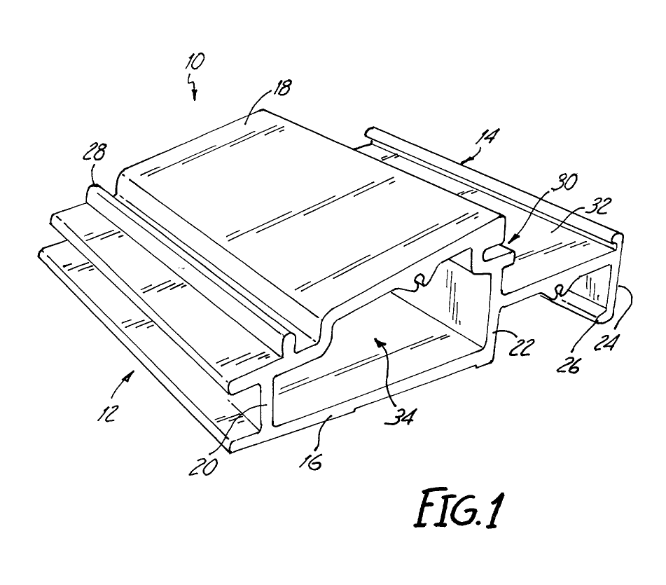

FIG. 1 is a perspective view of a portion of a patio door sill 10. The sill 10 is configured to be used with a swinging patio door and for simplicity is shown in an unfinished state without a patio door. The sill 10 comprises a front side 12 and a rear side 14. In addition, the sill 10 comprises a base portion 16, a top portion 18, a first vertical support 20, a second vertical support 22, and a third vertical support 24. Located on the bottom of the third vertical support 24 is a lip 26. Located on the top portion 18 is a screen door rim 28 and a weather stripping groove 30. Adjacent the top portion 18 is a door slot 32. A hollow area 34 is formed inside the sill 10 by the top 18, base 16, and first and second vertical supports 20, 22.

The front side 12, including the top portion 18, is that part of the sill 10 which will be located on the exterior of the building once the patio door is installed. As such, the screen door rim 28 is located near the front side 12. The rim 28 is configured for use with a screen door, so that once the patio door is installed in connection with the bottom sill 10, a screen door can be slidably mounted on the rim 28. Also near the front 12 of the sill is the hollow portion 34. The hollow portion 34 of the sill 10 is designed in part to allow water to be drained away from the door and to the outside of the sill 10.

The back side 14 is that side of the sill 10 which will be located on the interior of the building. Near the back side 14 are the weather stripping groove 30 and slot 32. The groove 30 is configured to receive a strip of weather stripping to assist in forming a seal when the swinging patio door is installed. The slot 32 is that part of the sill 10 which is configured to accept the door.

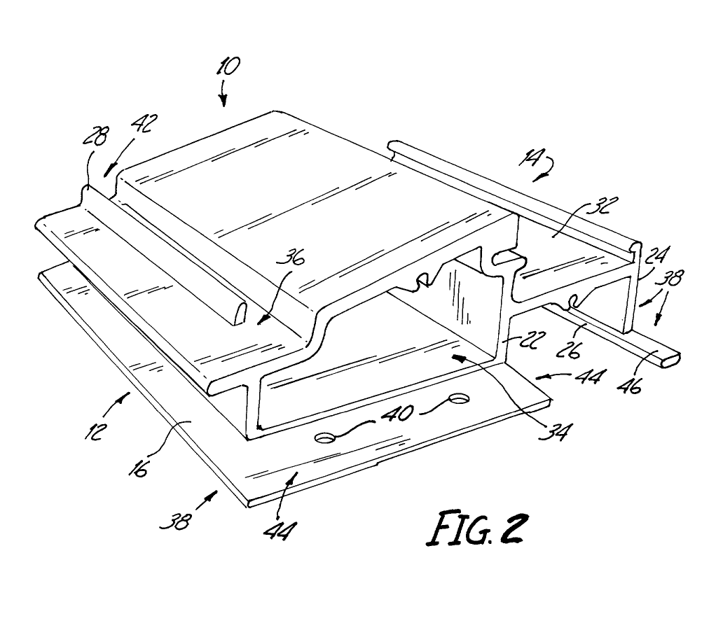

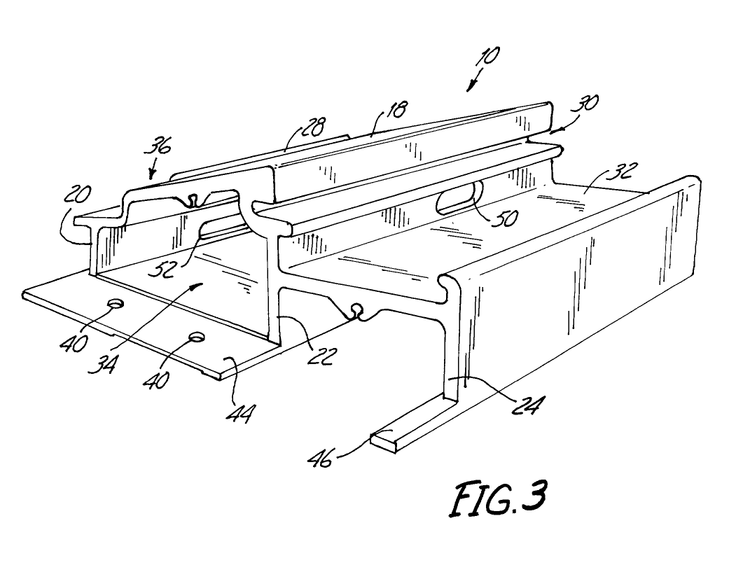

The portion of the sill 10 in FIG. 1 is shown before the end has been finished. To allow the vertical portions of the patio door frame to meet with and be attached to the bottom sill 10, certain finishing operations must be performed on both ends of the patio door sill 10. In addition to such structural requirements, other finishing operations are performed to ensure proper drainage of water away from the door and out the sill 10. FIGS. 2-3 illustrate the results of these finishing operations which prepare the sill 10 for assembly.

FIG. 2 shows the portion of the patio door sill 10 after two finishing operations have been performed. Shown once again in FIG. 2 are the sill 10 having at the front 12 a screen rim 28, and the first vertical support 20, top 18, base 16, and second support 22 which form the hollow area 34. Near the back 14 of the sill 10 are the third vertical support 24, and the lip 26 on its bottom. Also shown on the sill 10 are a screen weep 36, a cope 38, and two drill holes 40.

The screen weep 36 is located at an end of the screen door rim 28. To form the screen weep 36, a small amount of the screen rim 28 is removed from the sill 10. The screen weep 36 provides a location for any water or moisture which may collect in a track 42 formed behind the screen rim 28 to drain off the sill 10.

The cope 38 is located on the end of the sill 10 and refers to an amount of material removed from the sill 10 to allow for a vertical portion of the door frame to meet with the sill 10. The cope 38 involves removal of material at a ninety degree angle from the end of the sill 10. As such, the cope 38 cuts material from the sill 10, including material from the first vertical support 20, the top 18, and the second vertical support 21, to expose an area 44 on the base 16. In addition, material from the third vertical support 24 and door slot 32 is removed to create an exposed lip 46 on the third vertical support 24.

Another finishing operation performed on the sill is the addition of two drill holes 40. The holes 40 are drilled on the exposed area 44 of the base 16. The holes 40 are later used to allow screws to be used to attach a vertical door frame portion to the bottom sill 10.

FIG. 3 is a perspective view of a portion of the door sill 10 as viewed from the back 14. Illustrated in FIG. 3 are two finishing operations performed on the sill 10 to ensure proper moisture removal. Shown once again in FIG. 3 are the first vertical support 20, second vertical support 22, and third vertical support 24, the top 18, exposed base 44, exposed lip 46, and drill holes 40. Also shown is the door slot 32, and weather stripping groove 30.

The first finishing operation shown in FIG. 3 is a back weep 50. The back weep 50 is located on the second vertical support 22 just under the groove 30. The back weep 50 functions to allow any water which runs down the patio door to the sill to drain into the hollow area 34 of the sill. Another finishing operation shown in FIG. 3 is a front weep 52. The front weep 52 is located on the first vertical support 20. The front weep 52 allows any water in the hollow area 34 to drain out of the sill 10 and to the outside of the building.

In the past, performing the necessary finishing operations on a sill, including the cope 38, front, back, and screen weeps 52, 50, 36, and drill holes 40, was time consuming and expensive. Each operation was performed by hand to ensure the high tolerances required could be met. This involved several jigs to position and hold the sill during the finishing operation. It also involved removing the sill and repositioning it in another jig for each different operation. Typically, the finishing operations were performed on one end of the sill at a time. When the first end was finished, the necessary finishing operations were then performed on the second end. In addition to the time and expense involved, because the sills are often formed of fiberglass, these finishing operations created large amounts of dust.

The present invention is a machining center which is capable of automatically performing the required finishing operations on both ends of a patio door sill at the same time. The machining center is further configured to reduce dust created by these operations.

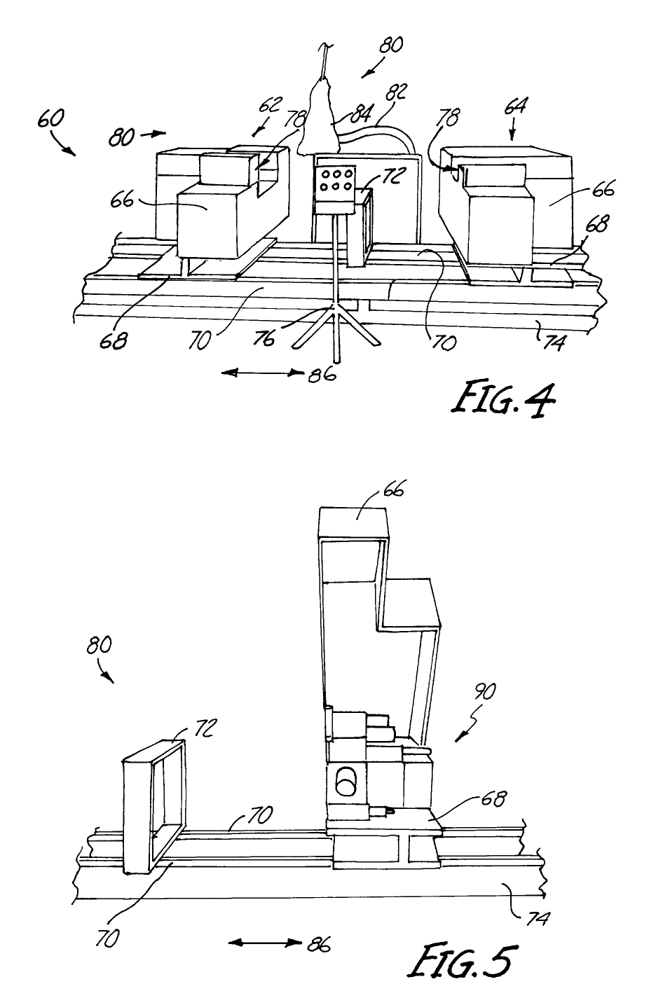

FIG. 4 is a perspective view of a machining center 60 capable of performing the finishing operations described above. The machining center 60 comprises a first and second end 62, 64 covered by hoods 66. Also shown are two platforms 68 which support the first and second ends 62, 64. The platforms 68 are slidably mounted on rails 70. Also shown are a middle support 72 and a base 74 upon which the entire machining center 60 is supported. The middle support 72 is currently unused, by may later be configured with a tooling device for performing machining operations on the middle of the sill. An operator control panel 76 is shown in front of the machining center 60.

Because the machining center 60 comprises two ends 62, 64, it is capable of performing the required finishing operations on both ends of a variety of products, and specifically a patio door sill. In addition, because the ends 62, 64 are slidably mounted on rails 70, each end 62, 64 is moveable in the direction indicated by arrow 86. This allows the distance between the ends 62, 64 to be adjusted, so that the machining center 60 can accommodate products having a variety of lengths.

Patio door sills vary in length, and typically range from as short as two feet to as long as nine feet. By moving the ends 62, 64 apart from each other, the machining center 60 is configured to accept a sill having a length of up to twelve feet, eleven inches. In addition, the ends 62, 64 can be moved toward one another so that a sill as short as one foot, eleven inches can be accommodated. Most commonly, patio door sills range from as short as about two feet to as long as about nine feet.

To move the ends, 62, 64, the platforms 68 may be interconnected to a chain driven system operated by a motor. In particular, a pneumatic motor may be used. The motor and chain drive system can be controlled to move the ends 62, 64 toward and away from each other. It may be preferable to use a chain driven system which connects the two ends 62, 64 so that as one end 62 is moved, the other end 64 is moved an equal amount. Though disclosed as utilizing a pneumatic motor, the machining center 60 can be configured with any suitable type of motor. In addition to a chain driven system, achieving the movement of the ends 62, 64 may be accomplished using any suitable method.

Once a sill is inserted into the machining center, the operator starts the machine so that the ends 62, 64 begin to move toward one another. The machining center maybe equipped with sensors at each end 62, 64 that are capable of sensing when the end 62, 64 has contacted the sill. Using this method, the machining center is self centering. In contrast to CNC machines, it is not necessary to block the sill in place so that all finishing operations are performed based on the blocked location of the sill. As a result, sills can be inserted into the machining center quickly, and the resulting finishing operations can be performed very accurately.

The hoods 66 on each end 62, 64 cover the tools and devices necessary for conducting the finishing operations. Each hood 66 has an aperture 78 which is configured to allow a sill to be inserted into the end 62, 64 and be clamped in place during the finishing operations. The hoods 66 are hinged and may be connected to a hydraulic or pneumatic system allowing them to be raised, though during normal operation of the machine 60, they remain in the closed position.

One important function of the hoods 66 is to reduce the amount of dust that accumulates in the environment of the machining center 60. This is particularly important because many parts of the machining center 60 react adversely to dust, such as bearings used to allow the platform 68 to move smoothly along the rails 70, and the motors and bearings used to operate and move the tools.

In addition to the hoods 66, an optional dust removal system 80, comprising air hoses 82 and collection bags 84, may be included on the machining center 60 to reduce dust caused by the finishing operations. The hoses 82 are connected to a vacuum source which serves to collect the dust from the area adjacent the hose 82. From the hoses 82, the dust is taken to the collection bags 84 where it is stored until it is disposed of.

The operator control panel 76 may be used to connect the tools and motors on the machining center 60 to a control system for controlling the operations of the machining center 60. The operator control panel 76 provides an interface between the control system used to control the machining center and the operator. One suitable control system is a programmable logic controller (PLC). There are numerous options for programming the PLC, and several methods of using the PLC to operate the machining center 60 in a more efficient manner, one of which is described more fully below.

The machining center 60 may further be configured with a mechanical set position for each length of door sill finished by the machine. Upon inserting the sill into the machining center 60, an operator may select a set position corresponding to the length of the sill. The set position ensures when the two ends 62, 64 are moved apart to allow the sill to be removed, the ends 62, 64 move to a position only slightly larger than the length of the sill, rather than traveling the full length of the rails so that they end up twelve feet apart. This increases efficiency and cycle time of the machine when several sills of the same length are being machined because after one sill is finished, the ends 62, 64 open only as far as necessary to allow insertion of the next piece.

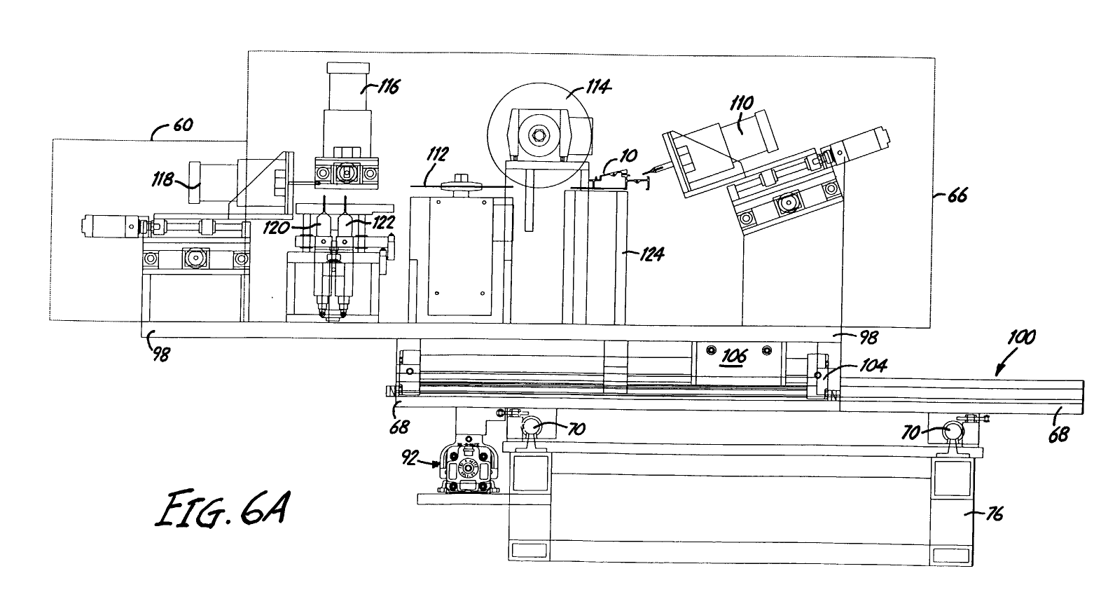

FIG. 5 is a view of a portion of the machining center 60 in which one of the hoods 66 is raised. Under the hood 66 is located a head 90 comprising a plurality of tooling devices used to perform the finishing operations. More clearly visible is the platform 68, the rails 70, and the base 74.

The base 74 is preferably made from tubular steel. The platform 68, set offs, and base plates upon which the tools are mounted are preferably formed of aluminum. Aluminum is strong, yet lightweight, so that the overall weight of the head 80 is kept to a minimum. Keeping the ends 62, 64 as light weight as possible is important to prevent stress to the bearings and the pneumatic motors which are used to move the ends 62, 64 on the rails 70.

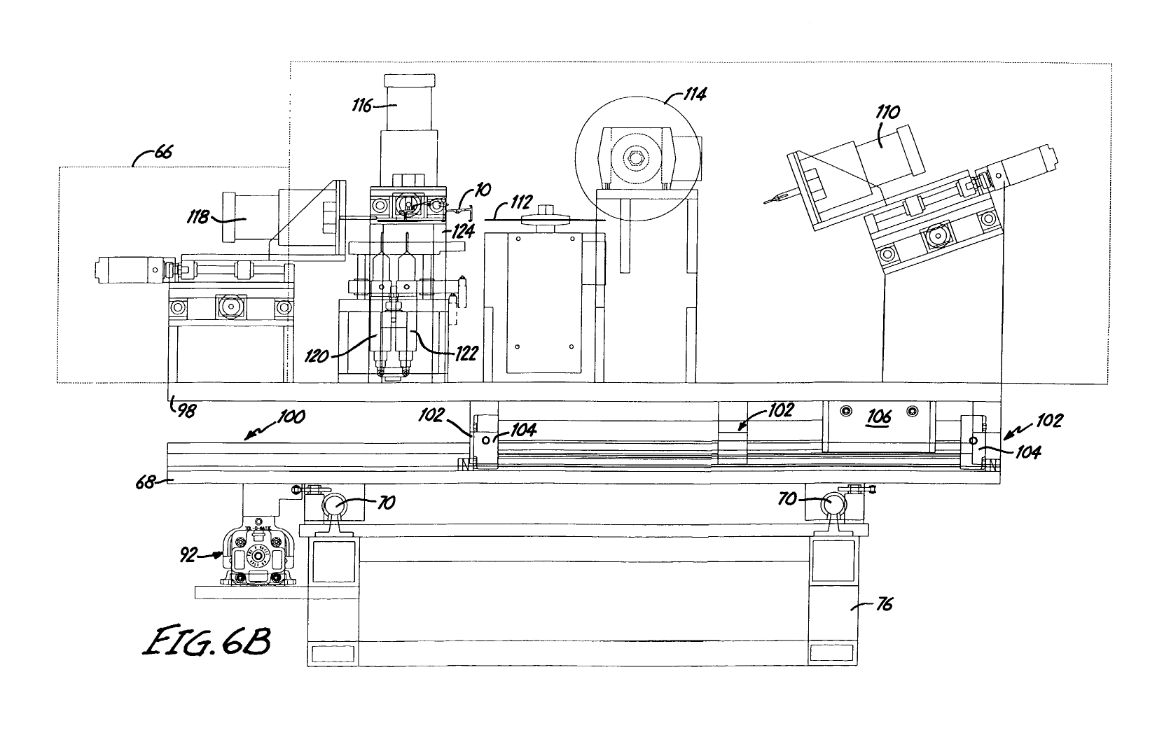

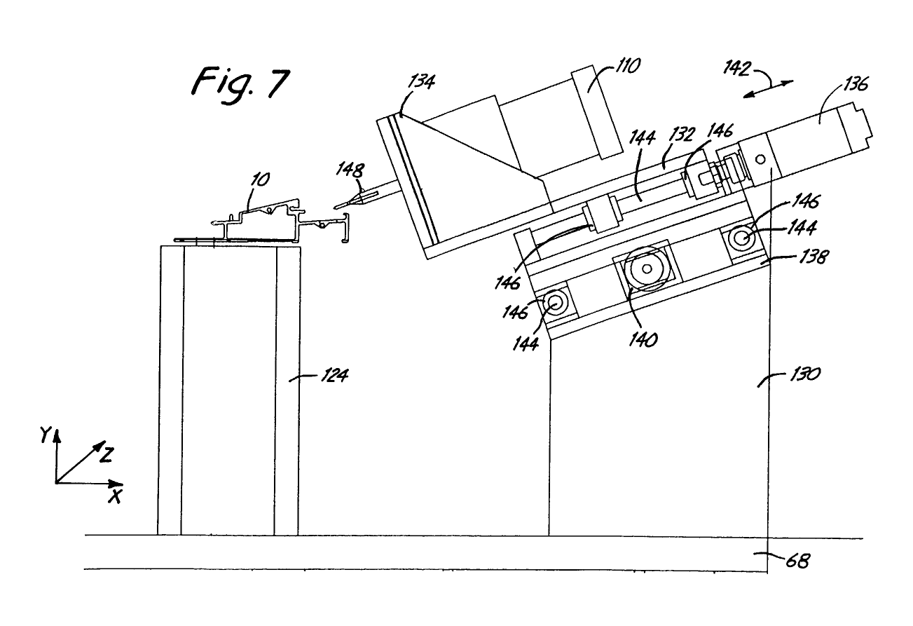

FIGS. 6A and 6B are end views of the head 80 of the machining center 60. The tools and their positions are more visible in FIGS. 6A and 6B, and the two figures also illustrate a manner in which the ends may be moved to allow multiple finishing operations to be performed on a sill. Shown in FIG. 6A is the base 76 upon which the machining center 60 is mounted. More visible is the platform 68, the rails 70, and also shown is a pneumatic motor 92 (described above) which can be used to move the ends 62, 64 along the rails 70. As described above, the ends 62, 64 are movable along rails 70 to allow varying lengths of door sills to be finished by the machining center.

In addition to moving in the direction of the length of the sill, the machining center is also configured to move in the direction of the width of the sill. Shown in FIG. 6A is a second platform 98 upon which the head 80 is mounted. Below the second platform 98 are rails 100, bearings 102, pneumatic motors 104, and a connection bracket 106.

The second platform 98 is mounted upon rails 100 at the connection bracket 106. The pneumatic motors 104 are operatively coupled to the second platform 98 using the connection bracket 106 and can be controlled to move the platform in the direction indicated by the arrow 108. To enable the second platform 98 to slide along rails 100, bearings 102 may be provided at various suitable locations. In FIG. 6A, three bearings 102 are provided; two of which are located at either end of the second platform 98 and a third which is located near the middle of the second platform 98. By moving the second platform 98 on rails 100, the sill can be positioned proximate the desired tool device during the finishing operation performed by that tool, as described more fully below.

Located on the second platform 98 are the tooling devices required for performing the finishing operations on the sill. Shown are a back two-axis router 110, a horizontal blade 112, a vertical blade 114, a vertical one-axis router 116, a front two-axis router 118, and two vertical drill heads 120, 122. In addition to these finishing tools, a sill support 124 is shown upon which is located the sill 10.

Unlike the back router 110, the blades 112, 114, the vertical router 116, the front router 118, and the drills 120, 122, the sill support 124 is not located on the second platform 98. Instead, the sill support 124 is connected to the platform 68 so that while the sill support 124 is moveable in the direction of the length of the sill, it does not move in the direction of the width of the sill. In other words, as the second platform 98 moves, the finishing tools 110-122 are caused to move, but the sill and sill support 124 remain stationary.

FIG. 6A shows the machining center in the forward position. When in the forward position, the sill 10 is inserted into the machining center via an aperture in the hood 66. The location of the hood 66 is indicated in FIG. 6A by dashed lines. Once inserted, the sill 10 is held on the support 124, and is located adjacent the drill heads 120, 122, the front router 118, and the vertical router 116.

FIG. 6B shows the machining center in the start position. After a sill is inserted into the machining center and the machining center is activated, the second platform 98 is moved to the start position shown in FIG. 6B. Though the second platform 98, and thus the tools located on the platform 68 move, the sill 10 on the sill support 124 remains stationary.

As the second platform 98 travels from the forward position to the start position, the horizontal blade 112 and vertical blade 114 pass the sill 10. As the sill moves past the blades 112, 114, the blades 112, 114 are activated so that the blades 112, 114 cut the cope 38 in the sill 10 as it travels past them. After the sill 10 passes the blades 112, 114 and the cope 38 is cut, the sill 10 is positioned at the most forward position. When in this position, the second platform 98 has been moved so that the back router 110 is now located near the sill support 124. The back router 110 performs the back weep 50 while the sill 10 is in the forward position. Once the cope 38 and back weep 50 have been performed, the second platform 98 returns to the forward position illustrated in FIG. 6A.

After returning to the forward position of FIG. 6A, the sill 10 is positioned such that the remaining three finishing operations can be performed. The remaining finishing operations, the screen weep 36, front weep 52, and drill holes 40 are all performed nearly simultaneously.

After the second platform 98 is moved back to the position shown in FIG. 6A, the screen weep 36 is formed on the sill using the vertical router 116. At nearly the same time, the front weep 52 is formed using the front router 118. While the screen weep 36 and front weep 52 are performed, the vertical drills 120, 122 drill two holes 40 into the sill 10.

After the final three finishing operations are performed, the sill 10 can be removed from the machining center, and another sill can be inserted for finishing. In the past, the time required to perform these operations by hand was significant. Using the machining center described above, all the required the finishing operations can be performed in about 35 seconds. As a result, the machine greatly improves efficiency and lowers the cost of finishing the sills.

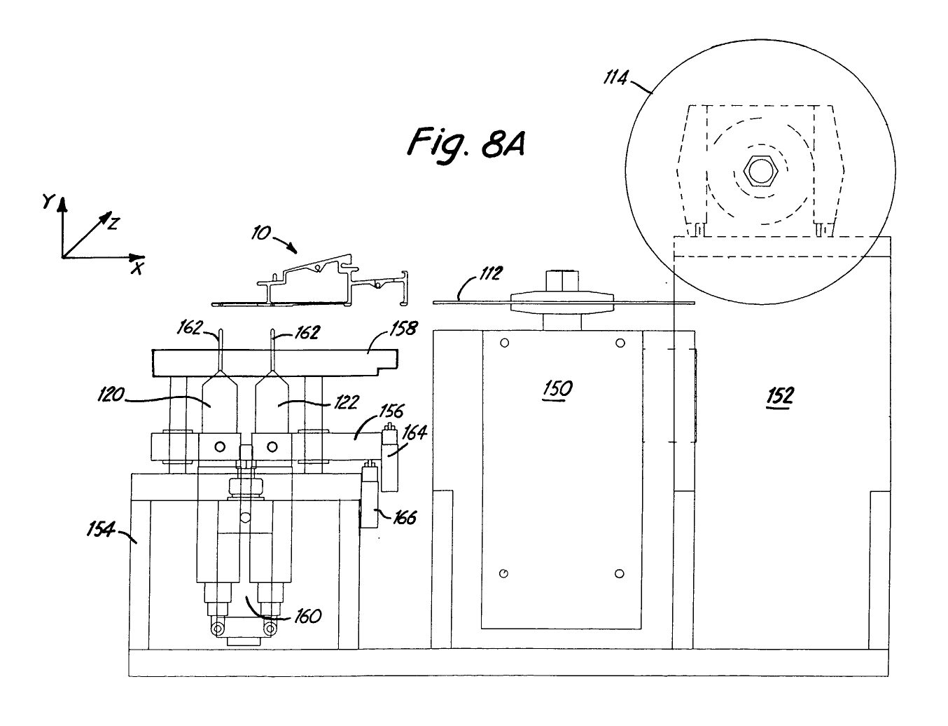

FIGS. 7-9 provide additional details regarding the operation of the back router 110, blades 112, 114, vertical router 116, front router 118, and drill heads 120, 122. FIG. 7 is a view of a portion of the machining center more clearly showing the back router 110. Shown in FIG. 7 is the sill 10 on sill support 124, the back router 110, and platform 68. Also shown is a stand off 130, a first base plate 132, a gusset 134, a first air cylinder 136, a second base plate 138, a second air cylinder 140, and an arrow 142.

The back router 110 is mounted on the first base plate 132 at gusset 134. Connected to the first base plate 132 is the first air cylinder 136. The air cylinder 136 operably connects to the back router 110 using rails 144 and bearings 146. Located below the first base plate 132 is a second base plate 138. Similar to the first air cylinder 136, the second air cylinder 140 is operably connected to the second base plate 138 using rails 144 and bearings 146. The second base plate 138 in turn connects to the stand off 130. The stand off 130 is dimensioned so that the back router 110 is positioned at the desired height for performing the back weep 50 when the sill 10 is located on the sill support 124.

The back router 110 is a two-axis router because it is capable of moving along two axis. The first axis is indicated by the arrow 142. The second axis is in the z-direction, as indicated by the axis as labeled on FIG. 7. The first air cylinder 136 serves to move the back router 110 in the directions indicated by arrow 142. In doing so, the first air cylinder 136 is activated so that the base plate 132 is moved along rails 144, causing the back router 110, which is mounted on the base plate 132, to likewise be moved. Similarly, when the second air cylinder 140 is activated, base plate 138 is moved along rails 144. Because the back router 110 is interconnected to the base plage 138, the second air cylinder 140 causes it to move in the z direction.

The back router 110 is equipped with a router bit 148. The back router 110 performs the back weep 50 by first moving forward using the first pneumatic cylinder 136 to cause the router bit 148 to be inserted into the sill 10 at the desired location on the second vertical support 22. Next, while the bit 148 is contacting the sill 10 at the second vertical support 22, the second pneumatic cylinder 140 causes the back router 110 to move in the z-direction for about an inch. Once the back weep 50 is created, the back router 110 can be moved away from the sill using the first pneumatic cylinder 136, and returned to its home position.

Though the size of the back weep 50 may vary, it is preferably about an inch long and about a quarter inch high. Thus, using a suitable quarter inch router bit 148, and controlling the second cylinder 126 so that the router 110 is moved about an inch in the z direction ensures that a back weep 50 having the desired dimensions is created. The size of the back weep 50 is not so limited, and may be of any desired or suitable size.

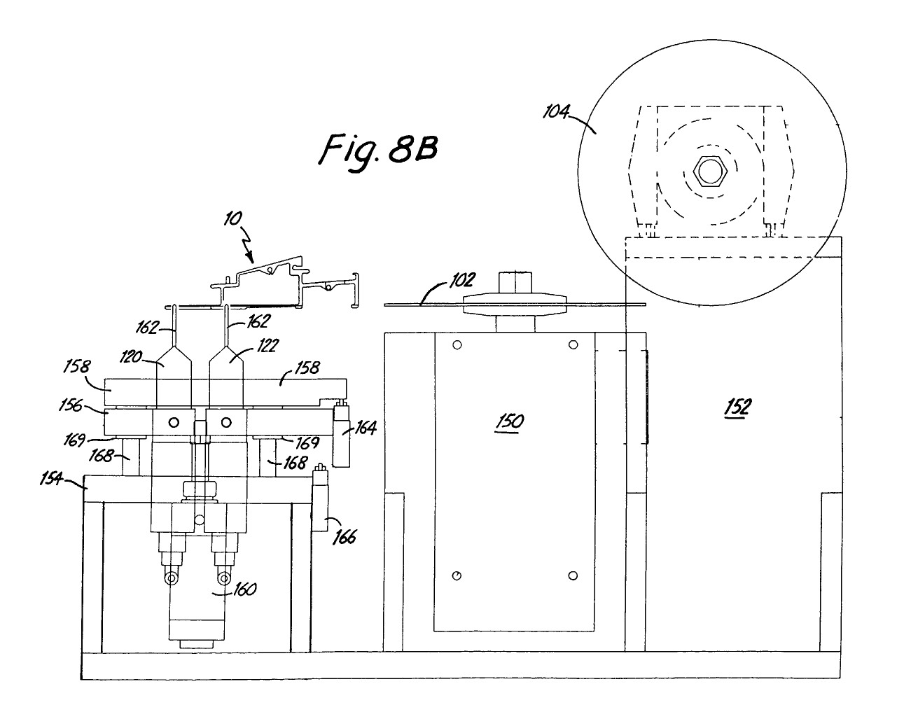

FIGS. 8A and 8B are views of a portion of the machining center more clearly illustrating the blades 112, 114 and drill heads 120, 122. For the sake of simplicity, in FIGS. 8A and 8B the sill is shown as a cross section, and the sill support 124 is omitted. The location of the sill 10 in FIGS. 8A and 8B corresponds to the location of the sill 10 when the platform 68 is in the start position.

Shown in FIGS. 8A and 8B are the horizontal and vertical blades 112, 114. The horizontal blade 112 is mounted on a base plate 150, and the vertical blade 114 is mounted on a base plate 152. The type of blades 112, 114 used may vary based on the type of product machined by the machining center. When used to machine a patio door sill, the blades 112, 114 are preferably blades capable of cutting fiberglass, and may comprise ⅛″ carbine cutting blades.

The blades 112, 114 are configured to perform the cope 38, and thus are oriented at a ninety degree angle from one another. The base plates 150, 152 are dimensioned so that the blades 112, 114 are positioned to perform the cope 38 on the sill 10 when the sill 10 is located on the sill support 124. Using two blades 112, 114 to perform the cope 38 in such a manner makes it possible to perform a cope 38 with a high degree of precision which meets the required tolerances.

Near the blades 112, 114 are the drill 120, 122. The drills 120, 122 are mounted on a stand off 154 and are connected via horizontal base plate 156. Near their top, the drills 120, 122 extend through a top guide 158, and near their bottom, the drills 120, 122 are connected to an air cylinder 160. The air cylinder 160 is operably connected to the horizontal base plate 156 so that the drills 120, 122 are movable in the y direction. The drills 120, 122 further comprise drill bits 162 which are used to create the drill holes 40 on the sill 10.

The drills 120, 122 may further comprise a first micro-switch 164 and a second micro-switch 166. The first micro-switch 164 is located on the horizontal base plate 156 and can be used to indicate when the drills 120, 122 have moved into position to begin drilling holes into the sill 10. The second micro-switch 166 is located on the vertical portion of the stand off 154 and may be used to indicate when the drills 120, 122 have returned to their home position.

As shown in FIG. 8A, the drills 120, 122 are located in the start position. While in the start position, the first micro-switch 164 is not activated. However, while in the start position, the drills 120, 122 are positioned such that the second micro-switch 166 is positioned in contact with the horizontal base plate 156. When in such a position, the second micro-switch 166 ensures that the drills 120, 122 are not activated.

FIG. 8B shows the drills 120, 122 after they have been moved to a second position by the air cylinder 160. In moving to the second position, the air cylinder 160 moves the horizontal base plate 156 in the y direction along two vertical rails 168. Bearings 169 may be provided in connection with the horizontal base plate 156 to facilitate its movement along rails 168. When in the second position, the drills 120, 122 are located such that the drill bits 162 can form the drill holes 40 in the sill 10.

To ensure the drills 120, 122 extend as far as desired, the first micro-switch 164 can be used. When the first micro-switch 164 contacts the guide plate 158, the micro-switch 164 can signal that the drills 120, 122 have reached the proper position for drilling the holes 40. After the holes 40 have been drilled, the air cylinder 160 can be controlled to move the drills 120, 122 back to their start positions. The second micro-switch 166 can signal that the drills 120, 122 have reached the start position when the horizontal base plate 156 contacts the second micro-switch 166. Though discussed in terms of micro-switches, any suitable method of activating the drills at the proper time can be used in connection with the present invention.

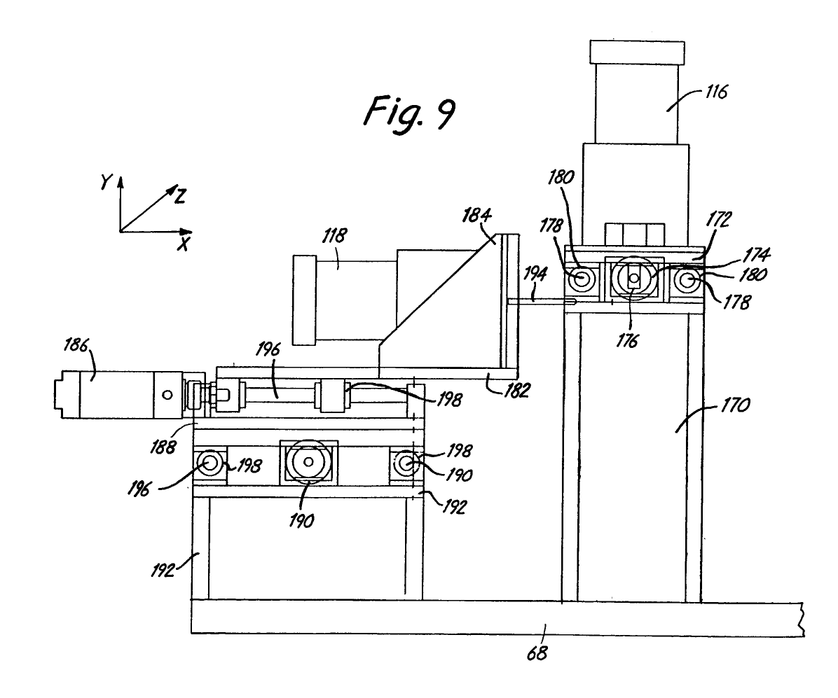

FIG. 9 is a portion of the machining center more clearly illustrating the vertical router 116 and front router 118. For simplicity, the sill 10 and sill support 124 are not shown in FIG. 9.

The vertical router 116 comprises a stand off 170, base plate 172, air cylinder 174, router bit 176, rails 178, and bearings 180. The vertical router 116 is mounted using the stand off 170 to ensure the vertical router 116 is positioned at the correct height for performing the screen weep 36 when the sill 10 is located on the sill support 124. The vertical router 116 is connected to the base plate 172, which in turn is operably connected to the air cylinder 174.

In creating the screen weep 36, the vertical router 116 moves only in the z direction, and thus is a one axis router. To move the router 116 as desired, the air cylinder 174 is activated to cause the base plate 172 to move along the rails 178 on bearings 180. As the base plate 172 is moved, the vertical router 116 likewise moves. Thus, the screen weep 36 is created by activating the vertical router 116 and controlling the router in the z direction until the router bit 176 contacts the sill 10 at the screen door rim 28. The vertical router 116 is further moved in the z direction so that the router bit 176 removes a portion of the rim 28 to create the weep 36 of the desired length. The screen weep 36 may vary in size depending on the type of product finished using the machining center. When used on a patio door sill, one desirable length of the screen weep 36 is about 9/16 of an inch. After the screen weep 36 is created, the vertical router 116 can be returned to its home position using the air cylinder 174.

Near the vertical router 116 is the front two axis router 118. The front router 118 is mounted on a first base plate 182 using a gusset 184. The base plate 182 is coupled to a first air cylinder 186 so that the front router 118 can be moved in the x-direction. The front router 118 further comprises a second base plate 188 coupled to a second air cylinder 190. The second air cylinder 190 allows the front router 118 to be moved in the z direction.

The second base plate 188 connects to a stand off 192, which serves as the base of the router 118 and places the router 118 at the proper height for performing the front weep 52. To create the front weep, a router bit 194 is provided on the front router 118. The front router 118 is caused to move in the x direction toward the sill 10 using the first air cylinder 186. The first air cylinder 186 moves the base plate 182, which is interconnected to rails 196 at bearings 198. Thus, as the first air cylinder 186 is actuated, the base plate 182 is moved forward along rails 196, so that the front router 118 moves toward the sill until bit 194 contacts the sill 10 at the desired location on the first vertical support 20.

Once the bit 194 has contacted the sill 10, the front router 118 is moved in the z direction using the second air cylinder 190. The second air cylinder 190 moves the second base plate 188, which is interconnected to rails 196 at bearings 198. Thus, as the second air cylinder 190 is actuated, the second base plate 188 is moved in the z direction along rails 196, so that the router bit 194 contacts the sill 10 along the first vertical support 20 to remove material and create the front weep 52. Similar to the back weep 50 described above, the front weep 52 may vary based on the type of product machined by the machining center. For patio door sills, the front weep 52 is typically the same size as the back weep 50. Once the front weep 52 is created, the router bit 194 is removed from the sill using the first air cylinder 186, and the front router 118 is returned to its home position.

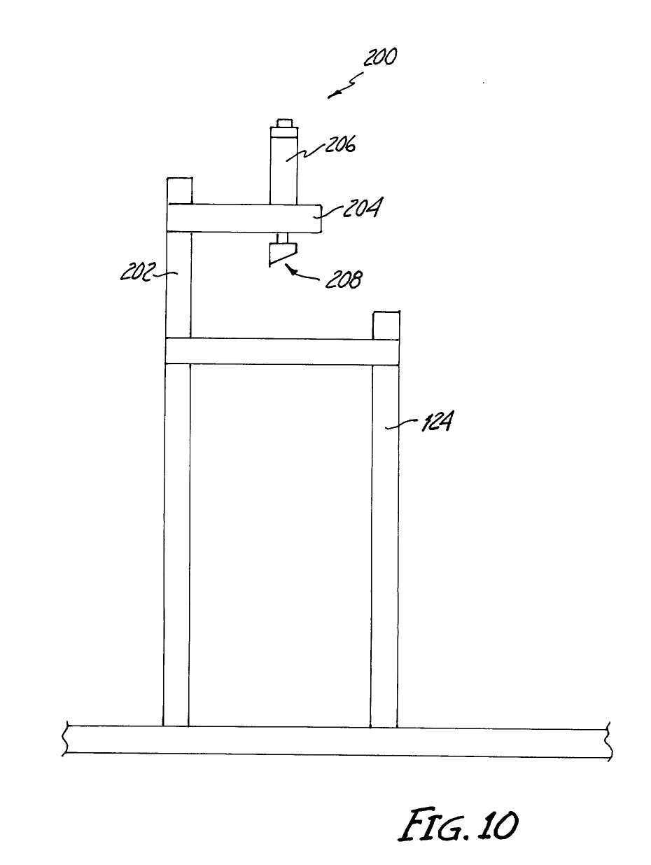

Once a sill is inserted into the machining center, the sill must be held in place using some method. FIG. 10 illustrates one such suitable method of restraining the sill comprising a pneumatic clamp system 200. The pneumatic clamp system 200 maybe incorporated to be used with the sill support 124. Shown in FIG. 10 is the sill support 124, a support rod 202, a vertical support 204, an air cylinder 206, and a foot 208. The support rod 202 is connected to the sill support 124, and the vertical support 204 extends from the support rod 202. Connected to the vertical support 204 is the air cylinder 206, which is operatively coupled to the foot 208. The vertical support 204 is located such that the foot 208 can be located above the sill 10 so that the foot 208 matches the contour of the top portion 18 of the sill 10. By activating the air cylinder 206, the foot 208 can be forced against the sill located on the sill support to hold the sill in place.

In addition to pneumatic clamps, any other suitable type of clamping device would be adequate, including for instance suction cups, hydraulic clamps, or mechanical clamps.

As described above, many of the tooling devices are slidably mounted on rails and are operatively coupled to pneumatic cylinders allowing them to be movable along one or more axis. It is possible to use the PLC (described above with reference to FIG. 4) to control each of the tooling devices so that the tooling device is actuated at the proper time, and is moved to the proper locations for performing the desired finishing operation. In addition, the PLC can be configured to control the clamps used to hold the sill in place during the finishing operations. To accomplish this, the PLC can be configured to control not only the tooling devices, but also the pneumatic cylinders.

One method of programming of the PLC is to program the PLC to control the tooling devices of only one head of the machining center. The PLC can further be programmed so that the tooling devices of the other head mimic exactly the functions performed by the tools of the programmed head. Such a method of programming the PLC may simplify the programming required to control the machining center because only one head needs to be programmed. After the first head is programed so that the tooling devices are configured to perform the desired finishing operations, the PLC can be configured so that the second head performs the same operations as the first head.

As is clear from the above discussion, the present invention is an improvement over performing similar finishing operations using a CNC machine. The above described machining center is much faster because the machining center is self centering and controlled by a PLC. CNC machines may be slower because CNC machines are run based on an X-Y coordinate program, which requires each sill to be set and blocked in such a manner that the CNC machine can orient its machining tools relative to the sill in the desired X-Y-Z planes. In addition, due to the multiple operations that are necessary to finish the end of the sill, the CNC machine would have to change tool heads at least once, and possibly many more times. Finally, the machining center is configured to perform finishing operations on both ends of the sill at the same time. A CNC machine is typically configured to perform such operations on one end at a time.

Although the present invention has been described with reference to preferred embodiments, workers skilled in the art will recognize that changes may be made in form and detail without departing from the spirit and scope of the invention. In particular, though described in terms of routers, the front and back weeps and the screen weep may be performed by any device suitable for removing material from the sill in the desired location and at the desired size. Also, though described in terms of two blades, the cope operation may be accomplished using a dado stack, or any other suitable configuration of cutting tools capable of performing the desired cope. Finally, though described in terms of performing the finishing operations on a patio door sill, the machining center is not so limited, and may be used to perform similar finishing operations on a variety of products.

1. A machining center for machining both ends of a work piece, the machining center comprising:
a first head having a plurality of machining tools for performing multiple finishing operations on an end of a work piece;
a second head having a plurality of machining tools for performing multiple finishing operations on an opposite end of the work piece;
wherein the first and second heads are moveable in a first direction to allow the machining center to accommodate work pieces having varying lengths.

2. The machining center of claim 1 wherein the first and second heads are moveable in a second direction.

3. The machining center of claim 2 wherein the work piece comprises a patio door sill.

4. The machining center of claim 3 wherein the plurality of machining tools of the first and second heads comprises:
means for creating a weep;
means for machining the sill to accommodate a vertical frame member; and
means for creating screw holes in the sill.

5. The machining center of claim 4 wherein means for creating a weep comprises a router.

6. The machining center of claim 5 and further comprising:
a back router for creating a back weep;
a front router for creating a front weep; and
a screen router for creating a screen weep.

7. The machining center of claim 4 wherein the means for machining the sill to accommodate a vertical frame member comprises two blades for performing a dado cut.

8. The machining center of claim 4 wherein the means for creating screw holes in the sill comprises a drill.

9. The machining center of claim 1 and further comprising a dust minimizing system.

10. The machining center of claim 9 wherein the dust minimizing system comprises an air evacuation system.

11. The machining center of claim 9 wherein the dust minimizing system comprises a protective hood covering the first and second heads.

12. A sill machine for simultaneously finishing both ends of a patio door sill, the sill machine comprising:
a sill support for supporting a sill;
a first head for performing finishing operations on an end of the sill;
a second head for performing finishing operations on the other end of the sill;
a first platform supporting the first and second heads and the sill support, wherein the first platform is moveable in a first direction so that sills having varying lengths can be accommodated by the sill machine; and
wherein the first platform further comprises a second platform upon which is supported a plurality of tools for performing the finishing operations, wherein the second platform moveable in a second direction.

13. The sill machine of claim 12 wherein the second platform moves relative to the first platform.

14. The sill machine of claim 13 wherein the second platform moves between a start position and a forward position.

15. The sill machine of claim 14 wherein the plurality of tools on the first and second heads comprises:
a back router for creating a back weep;
two blades for performing a cope to allow the sill to accommodate a vertical frame member;
a router for creating a front weep;
a router for creating a screen weep; and
a drill for drilling screw holes.

16. The sill machine of claim 15 wherein the back router and blades are configured on the second platform so that when the second platform is in the forward position, the back router and blades are located proximate the sill and the sill support.

17. The sill machine of claim 16 wherein the front router, screen router, and drills are configured on the second platform so that when the second platform is in the start position, the front router, screen router, and drills are located proximate the sill on the sill support.

18. The sill machine of claim 17 and further comprising a clamp system for holding the sill in place on the sill support during the finishing operations.

19. The fabricating machine of claim 18 and further comprising a programmable logic controller for controlling the finishing operations.

20. A machine for performing multiple operations on an end of a sill, the machine comprising:
a sill support for supporting the sill during the multiple operations;
a back router for performing a back weep on the sill;
a front router for performing a front weep on the sill;
a screen router for performing a screen weep on the sill;
a drill for drilling a hole in the sill; and
horizontal and vertical blades configured to perform a cope on the sill.

21. The machine of claim 20 wherein the back router, front router, screen router, drill, and horizontal and vertical blades are moveable with respect to the sill support.

22. The machine of claim 21 wherein the back and front routers comprises two axis routers moveable in two directions.

23. The machine of claim 22 wherein the screen router comprises a one-axis router moveable in one direction.

24. The machine of claim 23 wherein the drill is moveable in the vertical direction.

25. The machine of claim 24 wherein the back, front, and screen routers and the drill are moveable using a pneumatic cylinder operatively coupled to the routers and the drill.

26. The machine of claim 25 and further comprising a programmable logic controller for controlling the multiple operations performed by the machine.

27. The machine of claim 21 wherein the back router, front router, screen router, drill, and horizontal and vertical blades are supported by a platform and the platform is configured to be moveable relative to the sill support.

28. The machine of claim 27 and further comprising a dust removal system.
